(19) United States
(12) Patent Application Publication
(10) Pub. No.: US 2006/0060785 A1
(43) Pub. Date: Mar. 23, 2006

(54) Component for detecting electromagnetic radiation, particularly infrared radiation, infrared optical imaging unit including such a component and process for implementing it

(75) Inventor: Sebastien Tinnes, Tullins (FR)

Correspondence Address: BURR & BROWN, PO BOX 7068, SYRACUSE, NY, 13261-7068, US

(73) Assignee: ULIS, Veurey Voroize (FR)

(21) Appl. No.: 11/172,635

(22) Filed: Jul. 1, 2005

(30) Foreign Application Priority Data
Aug. 24, 2004 (FR) 04.09055

(51) Int. Cl. G01J 5/02

(52) U.S. Cl. 250/338.1

(57) ABSTRACT

This component for detecting electromagnetic radiation, particularly infrared radiation, comprises a vacuum or low-pressure enclosure (5) called the primary enclosure, one side (3) of which consists of a window (4) that is transparent to the radiation to be detected, at least one actual detector (6) located inside said enclosure substantially opposite the transparent window (4) and a means (13) of pumping residual gases or getter intended to maintain the vacuum inside said enclosure (5) at an acceptable level located inside a secondary enclosure (20) arranged outside the primary enclosure (5) and communicating freely with the latter.

The invention relates, generally speaking, to a component for detecting electromagnetic radiation, particularly infrared radiation, more especially intended to be used as an optical imaging component, such components being, for example, installed inside an infrared camera that operates at ambient temperature.

A more or less hard vacuum may be required inside such components in order to allow correct operation of the detector(s) used and, consequently, to provide reliable data and to increase the accuracy of measurements made or images acquired.

A pressure less than 10⁻² millibars is frequently required in order for such a detector to operate satisfactorily. They are therefore encapsulated in a hermetic enclosure inside which the required vacuum has been created. However, it is well known that, after sealing the encapsulation package that encloses the detector(s), thereby producing an enclosure containing a vacuum or low pressure, molecules of gas adsorbed in the surface of the various structural constituents inside the enclosure or dissolved in the outer layers of the substrate(s) on which the constituents in question are mounted can be released (outgassing). These gases mainly consist of hydrogen, oxygen, carbon dioxide and water vapour. This affects the vacuum inside the enclosure when the detecting component is formed significantly and, consequently, the properties and performance of such a component.

In order to combat this outgassing, integrating a material capable of absorbing and, generally speaking, pumping any gas molecules released is a well-known technique. Such a material is referred to as a “getter” and acts as a kind of pump.

The invention is therefore more particularly related to the method of placing such a getter inside an optical detecting or imaging component and to the corresponding process making it possible to activate the properties of said getter whilst maintaining the integrity of the components and other detectors contained in the vacuum or low-pressure enclosure.

Thermal detectors, especially detectors arranged as matrix arrays, capable of operating at ambient temperature, i.e. not requiring any cooling down to extremely low temperatures, or quantum detectors, which cannot operate unless they are cooled to a temperature close to that of liquid nitrogen, are widely used in the field of infrared imaging.

Uncooled detectors conventionally consist of bolometric or microbolometric detectors in which the variation in the electrical resistivity, which itself depends on the variation in the temperature of the detected scenes, is measured.

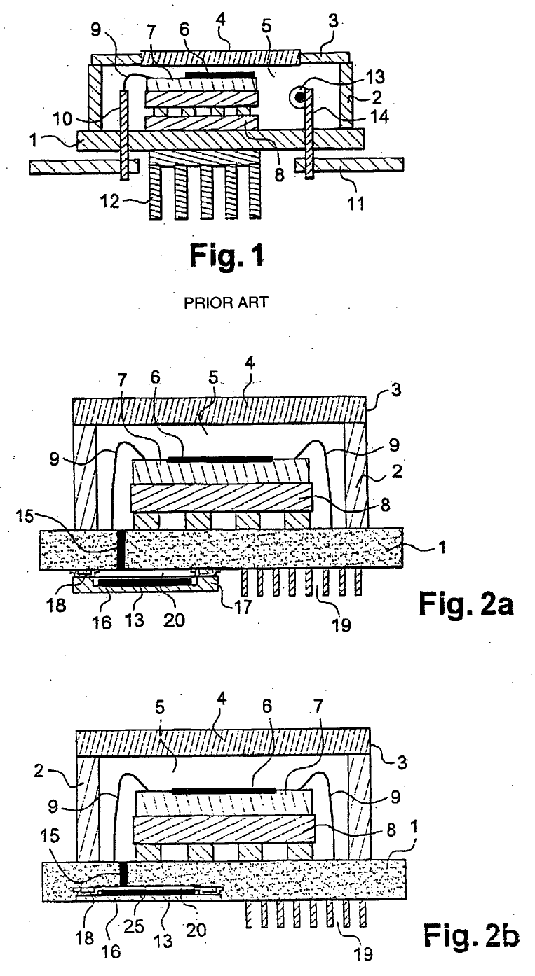

FIG. 1 shows a schematic view of an encapsulation package of a bolometric detector according to the prior art. It fundamentally comprises a substrate (1) made of a ceramic or metal material or even a combination of both these types of materials. This substrate constitutes the base of the package. It has side walls (2) and is hermetically sealed by means of a lid (3) which mainly has a window (4) that is transparent to the radiation to be detected, in this case infrared, and, for example, is transparent to radiation having wavelengths from 8 to 12 micrometers. An enclosure or cavity (5) is thus produced inside which there can be a vacuum or low pressure, typically a pressure less than 10⁻² millibars. The components that form this enclosure (5) are sealed in a manner that ensures that the helium leak rate is less than 10⁻¹² mbar.l/s.

Inside this enclosure, the substrate (1) essentially accommodates the actual detector itself positioned underneath the window (4) and which, in this case, is a microbolometer (6) associated with an interconnect circuit (7), this assembly being associated with a thermoelectric module (8) joined to substrate (1) by soldering or epoxy bonding for example. This module is intended to ensure temperature regulation in order particularly to serve as a reference, given the variable analysed by detector (6) and to guarantee a certain reproducibility of the measurements made.

The microbolometer assembly on an interconnect circuit (6, 7) is also electrically connected to the outside of the device by means of a connecting wire (9) associated with a standard input/output (10) which passes through said substrate and is connected to the electronic circuitry of the device in which it is installed, for example a camera, by means of an interconnecting and operating circuit (11).

The heat released by thermoelectric module (8) is dissipated by means of a heat sink (12) mounted on the lower surface of substrate (1) substantially underneath said module.

In order to maintain the vacuum inside enclosure (5) and as already stated, a getter (13) is placed inside the enclosure and connected to an electrical power input (14) that passes through substrate (1) and is also connected to interconnecting circuit (11).

In order to render this getter operational, before the package is sealed, it is necessary to perform an initial operation to activate said getter so as to make it able to pump gases likely to be released subsequently into the enclosure or cavity (5) by the various elements contained in it.

This initial activation is referred to hereafter in this description as “preliminary activation”. It is fundamentally different to subsequent reactivation conventionally performed on the sealed package which, according to the present invention, is no longer necessary.

This getter activation phase is obtained by heating the area of the package that contains the getter to a temperature from, conventionally, 300° C. to 900° C. This heating is achieved by various means, in particular (RF) current induction heating, but more often by placing the unsealed component in a heated vacuum chamber.

Frequently, in devices according to the prior art, the constituent material of the getter is sintered onto a resistive base consisting of a wire or a metal strip. In this case said getter is activated by the Joule effect by passing a sufficiently high electric current through said base in order to heat it to the desired temperature and, by heat conduction, heat the getter material.

The inherent advantages of using such a heating method are as follows:
ability to obtain complete activation of the getter material and hence maximum getter pumping capacity;
ability to re-activate the getter during the service life of the product insofar as the resistive base through which the current flows is accessible from outside the package;
quick activation of the order of several minutes;
temperature rise is confined to getter material only.

On the other hand, using this activation method has a certain number of drawbacks that counterbalance most of the above-mentioned advantages. These include:
overall dimensions: the getter material is placed inside the package close to the component or detector and this therefore increases the surface area of the package required to accommodate all the parts needed in order for it to operate;
need to make feed-throughs in the package through which electric power can flow: the getter activation current is actually of the order of 2 to 5 A;
emission of thermal radiation during activation of the getter material (especially in case of temperatures above 500° C.). This can damage or modify the characteristics of detectors, particularly microbolometric detectors.

If the getter material is activated by the effect of heating, the package or its lid, depending on the location where said getter is positioned, is heated to the getter activation temperature during the phase when the package is sealed or closed in a vacuum.

However, in this case there is a problem due to one limiting factor—the temperature which the lid (complete with window that is transparent to the radiation to be detected), and the package fitted with the thermoelectric module can withstand or even the problem of the temperature at which the soldered joints used to assemble the lid on the package melt because, generally speaking, this temperature does not exceed 300° C.

In other words, activating the getter during the sealing phase must not involve exceeding the temperature that the component parts of the package can withstand. Such a temperature is therefore far from ideal in order to activate the getter which, as already indicated, is capable of withstanding much higher temperatures. This incomplete activation of the getter leads to significantly degraded pumping properties over time and hence, consequently, a correspondingly reduced service life of the component in its entirety.

Admittedly, this activation process has the advantage of reduced cost in terms of the handling time required to obtain getter activation. On the other hand, and as the reader may now have understood, it also has the following drawbacks:
firstly partial activation of the getter material resulting, as already mentioned, in a shorter component service life;
inability to re-activate the getter during the service life of said component;
bulkier dimensions of the package because in order to achieve capacity equivalent to that of a getter activated by using the Joule effect, the getter volume must be increased in order to compensate for partial activation and achieve equivalent pumping capacity;
finally, activation takes longer (6 to 18 hours) which impacts the sealing cycle and reduces the capacity of vacuum pump machinery.

Summing up, regardless of the getter activation method envisaged, the getter is always fitted inside the package in the vicinity of the actual detector and this increases the surface area of the encapsulation package and, consequently, makes miniaturising the detection component more problematic, such miniaturisation being a constant objective in the field in question.

The purpose of this invention is to propose an encapsulated detection component, particularly an optical imaging component, that makes it possible to reduce, in particular, the overall dimensions of the encapsulation package in the plane of the detector itself. It also relates to a corresponding process that makes it possible to achieve sufficient thermal activation of the getter during the phase when the encapsulation package is sealed without damaging thermally sensitive parts, especially the detector(s) used, especially bolometric detectors.

This component for detecting electromagnetic radiation, particularly infrared radiation, comprises a vacuum or low-pressure enclosure, called the primary enclosure, one of the sides of which consists of a window that is transparent to the radiation to be detected, at least one actual detector located inside said enclosure substantially opposite the transparent window and a means of pumping residual gases intended to maintain the vacuum inside said enclosure at an acceptable level.

It is distinctive in that the means of pumping the residual gases is located inside a secondary enclosure arranged outside the primary enclosure and communicating freely with the latter.

In other words, the invention involves spatially separating the actual detection function from the function that maintains the vacuum inside the enclosure in which the detector that ensures detection is located, whilst making sure that the intrinsic properties of those components that fulfil detection functions and are sensitive to temperature do not deteriorate or diminish in any way.

According to the invention, the two enclosures, the primary and secondary enclosure respectively, communicate with each other through one or more pumping ports in the substrate that constitutes the base of the detector(s).

According to a first embodiment of the invention, the secondary enclosure is made in said substrate by hollowing out a cavity of appropriate shape and size and closed off by the base for the getter material by soldering.

In another embodiment of the invention, the getter is placed in a secondary base that is soldered onto the lower surface of said substrate.

The invention also relates to the process used to obtain sealing of the component's encapsulation package, particularly activation of the getter that it is intended to contain.

This process involves:
firstly, differentiated heating in a vacuum or low pressure, on the one hand, of a first part containing, in a primary enclosure or cavity, a substrate and the thermal detector(s), particularly microbolometric detectors, associated with a thermoelectric module and, on the other hand, of a second part consisting of the getter base to a temperature that ensures optimum degassing of the various elements contained in said first part and to a temperature, in excess of the previous temperature, ensuring optimum thermal preliminary activation of the getter contained in said second part within a relatively short period, respectively;
then subjecting both parts to a temperature that ensures one part is sealed onto the other part;
finally, bringing both parts into contact at the location provided for their cooperation and, consequently, joining them to each other with a leaktight joint.

According to the process in the invention, both parts have a protruding ring-shaped area in the location where they cooperate which has the necessary features to enable soldering. The process according to the invention also includes a stage involving increasing the temperature of both parts in order to obtain reflow of the soldering before or while the two parts are placed in contact with each other.

The manner in which the invention may be embodied and the resulting advantages will become apparent from the following embodiments shown by way of example, reference being made to the accompanying drawings.

FIG. 1 is, as already stated, a schematic cross-sectional view of a device according to the prior art.

FIGS. 2a and 2b are schematic cross-sectional views of two different embodiments of the present invention.

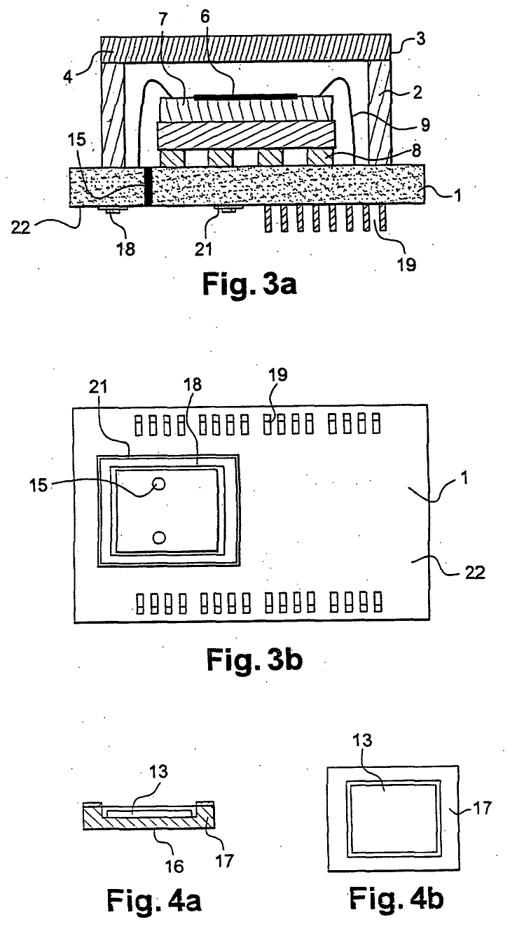

FIGS. 3a and 3b are schematic views, a cross-sectional view and bottom view respectively, of the first part of the component according to the invention.

FIGS. 4a and 4b are schematic views, a cross-sectional view and top view respectively, of the second part of the component according to the invention.

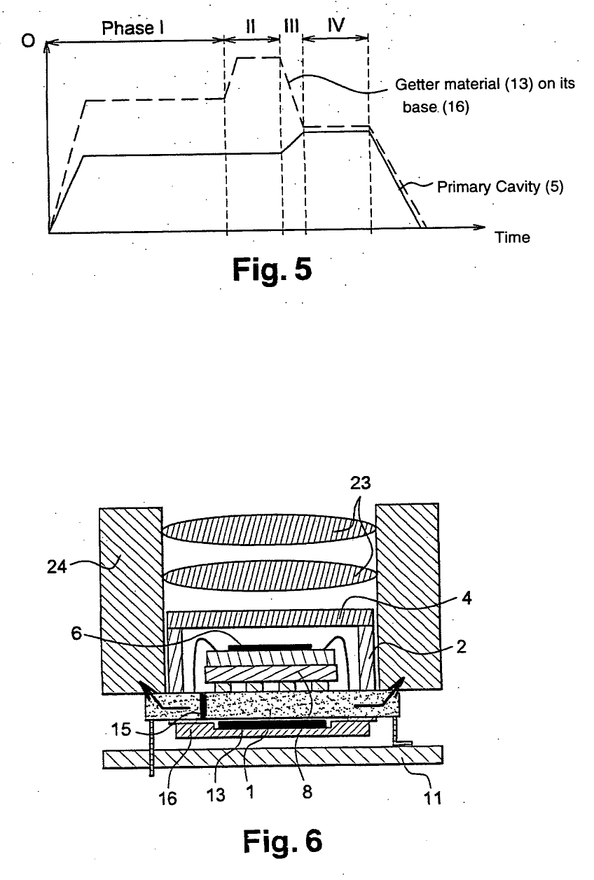

FIG. 5 is a diagram showing the variation in temperature over time of the two parts, in FIGS. 3 and 4 respectively, in accordance with the process described in this invention.

FIG. 6 is a schematic cross-sectional view of a particular embodiment of the invention.

The invention is described more particularly in relation to infrared detectors that operate at ambient temperature and which therefore use bolometers or microbolometers. It can nevertheless be used for electromagnetic radiation detectors, especially cooled infrared detectors.

FIGS. 2a and 2b show two different embodiments of the invention, the operating principle of both being identical. Two independent cavities are defined in FIG. 2a, these are, respectively:
a main or primary cavity (5) defined by substrate (1), side walls (2) and lid (3) including transparent window (4) and containing the bolometric detector (6) associated with its interconnect circuit (7) as well as thermoelectric module (8), this assembly being joined to substrate (1),
a secondary cavity (20) consisting of a base (16) possibly made of metal, ceramic or a semiconductor material, a material for pumping residual gases, i.e. a getter (13) being mounted on said base (16).

The two cavities thus defined communicate freely with each other via one or more pumping ports (15) through substrate (1) of said first cavity (5). Obviously, these ports (15) are sized to ensure sufficient movement of gas between primary cavity (5) where degassing is likely to occur, and the outside of the encapsulation package thus defined and, in this case, secondary cavity (20) that contains getter (13) with a view to optimising the action of the latter, thereby maintaining a sufficient vacuum level in the main cavity. The dimensions of these ports are determined conventionally by those skilled in the art and depend firstly on the hardness of the vacuum required in the main cavity and secondly on the nature of the materials used inside said main cavity.

FIGS. 3a and 3b show the distinctive features of the main or primary cavity (5) more clearly. They show, in particular, the electrical outputs (19) of the package and, in particular, of the primary cavity (5). These outlets are electrically connected to metallic tracks located inside the cavity and may be of various types: pins, metallised lands or output ribbon cables often referred to as “lead frames”.

As stated earlier, the primary (5) and secondary (20) enclosures are joined together by soldering. To achieve this, the lower surface (22) of substrate (1) has a metal ring (21) conventionally consisting of a primer layer, a barrier layer and a layer that allows wetting of a low melting-point soldering alloy (typically the melting point is less than 250° C.).

The primer layer consists of, for example, tungsten, chrome or titanium, i.e. a metal known to offer good adhesion and which is deposited in a known manner, by Physical Vapour Deposition (PVD) or screen printing for example.

The barrier layer also consists of a metal, especially nickel or platinum, known for its good imperviousness and ability to act as a diffusion barrier.

Finally, the wetting layer conventionally consists of gold.

Naturally, the pumping ports (15) open out inside the area defined by this metal ring (21). Consequently, the electrical outputs (19) of the main cavity are located outside said metallised ring.

Secondary cavity (20) (FIGS. 4a and 4b) essentially has a metal or ceramic or even semiconductor base (16) which is advantageously a good heat conductor.

The periphery of this base (16) and, if applicable, the peripheral edges (17) that delimit it (first embodiment of the invention—FIGS. 2a, 4a, 4b) have a metallised area that allows wetting of a soldering alloy and its dimensions match those of the metallised ring (21) applied to the lower surface (22) of base (1) of the main cavity.

Within the metallised area there is the getter (13), applied by direct deposition onto the substrate that constitutes base (16) or separately mounted on the latter using any well known technique such as those described in the document entitled “Chip Level Vacuum Packaging of Micromachines Using NanoGetters”—IEEE Transactions on advanced packaging, Vol. 26, No. 3, August 2003—Douglas R. SPARKS, S. MASSOUD-ANSARI and Nader NAJAFI.

In FIG. 2b it may be noted that base (16) can be entirely flat. In this embodiment of the invention, the getter (13) protrudes relative to the base and is accommodated in a cavity made in base (1) which is part of the main cavity.

In the other embodiment (FIG. 2a), the base has a peripheral rim (17) the height of which slightly exceeds the thickness of the getter.

The package according to the invention is fabricated essentially in three main steps or phases and special-purpose equipment is used to obtain heating in a vacuum of both cavities or parts of the package at different temperatures. An example of such equipment is a vacuum wafer bonding system such as models in the Electronic Vision Group 500 range, type 520.

In addition and advantageously, with a view to optimising production costs, such equipment can be used to seal several packages during a single production cycle.

During the first step (Phase I—FIG. 5), primary cavity (5) and base (16) fitted with the getter are kept separate from each other in order to perform a degassing stage on said cavity (5) and getter activation (13).

The degassing stage involves heating said primary cavity (5) and base (16) in a vacuum in order to eliminate as many gas molecules as possible adsorbed by the surface of the materials or parts from which they are made or which are dissolved in the first few micrometers of the materials of which substrate (1), walls (2), etc. are made in order to prevent these gas molecules outgassing inside the package after it has been sealed.

For cavity (5), this degassing stage is performed at a temperature the maximum value of which is dictated by the component that it contains and which is thermally the most fragile, in particular the thermoelectric module and the soldered joint. For said primary cavity (5), this degassing temperature is typically of the order of 150° C. to 200° C. In contrast and as can be seen on the graph in FIG. 5, this temperature is markedly higher for the base (16).

The getter preliminary activation stage is then performed (Phase II—FIG. 5). This is obtained by heating the base (16) equipped with getter (13) to the temperature recommended by the manufacturer of said getter in order to obtain optimum activation quickly. This temperature is typically 400° C. to 500° C. but this temperature may be much higher depending on the material from which the getter is made.

After activation, the temperature of base (16) is cooled to the melting temperature of the soldering alloy (18) applied to the soldering ring (21) on substrate (1) and, consequently, the temperature of said cavity (5) is increased to this same temperature.

The next stage (Phase IV—FIG. 5) involves, still inside the vacuum enclosure, bringing the periphery of base (16) into contact with the area defined by metallised ring (21) coated with soldering alloy (18), making sure that said soldering alloy (21) is overlaid on the metallised area of base (16), then increasing the temperature of both parts of the package that are in contact in order to obtain reflow of the soldering alloy (21).

The temperature of both parts is then cooled to below the melting point of the soldering alloy. This seals both parts of the package to each other, thereby forming two cavities, the primary (5) and secondary (20) cavity respectively, allowing the gases in each to mingle, thereby creating a space containing a vacuum with a getter capable of being thermally activated completely, preliminary activation having been obtained in a relatively short time, typically 10 minutes to 2 hours at most.

FIG. 6 shows a particular embodiment of the invention. In this embodiment, the package according to the invention is intended to be installed in an optical unit of an infrared imaging system, especially a camera.

The optical system (23) consisting of various lenses attached to lateral partitions (24) made of aluminium, for example, is shown, said unit being located above the actual component according to the invention. In this particular application of the invention, the heat released by the thermoelectric module (8) passes into substrate (1) which, the reader is reminded, is advantageously made of a material that is a good heat conductor, so that it can be dissipated in the considerable thermal mass provided by said partitions (24) that accommodate the optical unit. This optimises the removal of heat towards the front. This makes it possible to dispense with providing means of heat dissipation of the heat sink (12) type shown in FIG. 1 and, consequently, it is no longer necessary to drill the PCB (11) associated with the component to allow room for such a heat sink. This makes it possible to install such proximity PCBs that are smaller.

The present invention has a certain number of obvious advantages including making it possible to obtain optimised preliminary activation of the getter in a relatively short period of time without any danger of damaging the other parts of the detection component. During the getter activation stage, the thermal radiation produced by the latter is absorbed or reflected by the rear side of substrate (1) and cannot reach the bolometric detector or chip in which it is used and, more particularly, the chip microstructure which is likely to be damaged or have its characteristics modified by such thermal radiation.

1. A component for detecting electromagnetic radiation, particularly infrared radiation, comprising a vacuum or low-pressure enclosure (5), called the primary enclosure, one side (3) of which consists of a window (4) that is transparent to the radiation to be detected, at least one actual detector (6) located inside said enclosure substantially opposite the transparent window (4) and a means (13) of pumping residual gases or getter intended to maintain the vacuum inside said enclosure (5) at an acceptable level characterised in that the means of pumping the residual gases or getter is located inside a secondary enclosure (20) arranged outside the primary enclosure (5) and communicating freely with the latter.

2. A component for detecting electromagnetic radiation as claimed in claim 1, characterised in that the two enclosures, the primary (5) and secondary (20) enclosure respectively, communicate with each other through one or more pumping ports (15) in the substrate (1) that constitutes the base of the detector(s) (6).

3. A component for detecting electromagnetic radiation as claimed in claim 2, characterised in that the secondary enclosure (20) is made in said substrate (1) by hollowing out a cavity (25) of appropriate shape and size and closed off by the base (16) for the getter material (13) by soldering.

4. A component for detecting electromagnetic radiation as claimed in claim 2, characterised in that the getter (13) is placed in a base (16) that is soldered onto the lower surface (22) of said substrate (1).

5. A component for detecting electromagnetic radiation, according to claim characterised in that the detector(s) consist of a bolometer or microbolometer (6) and in that enclosure (5) also has a thermoelectric module (8) intended to ensure temperature regulation.

6. An infrared optical imaging unit, especially for a camera, consisting of various lenses (23) attached to lateral partitions (24) of said unit and including a component for detecting electromagnetic radiation according to claim 1 located underneath said lenses, characterised in that the substrate (1) of said component is in thermal contact with the lateral partitions (24) of the optical unit.

7. An infrared optical imaging unit as claimed in claim 6, characterised in that the component for detecting electromagnetic radiation which it contains does not have any heat sink to dissipate heat or equivalent means.

8. A process for obtaining sealing of the encapsulation package of a component for detecting electromagnetic radiation, particularly infrared radiation, characterised in that it involves:
firstly, differentiated heating in a vacuum or low pressure, on the one hand, of a first part containing, in a primary enclosure or cavity (5), a substrate (1) and the actual detector(s) (6) for said radiation and, on the other hand, of a second part consisting of the base (16) for a material for pumping residual gases or getter (13) to a temperature that ensures optimum degassing of the various elements contained in said first part (5) and to a temperature, in excess of the previous temperature, ensuring optimum thermal preliminary activation of the getter (13) contained in said second part within a relatively short period, respectively;
then subjecting both parts to a temperature that ensures one part is sealed onto the other part;
finally, bringing both parts into contact at the location provided for their cooperation and, consequently, joining them to each other with a leaktight joint.

9. A process for obtaining sealing of the encapsulation package of a component for detecting electromagnetic radiation as claimed in claim 8, characterised in that both parts have a protruding ring-shaped area in the location where they cooperate which has the necessary features to enable soldering, especially a metallised ring, at least one of which is coated with a soldering alloy.

10. A process for obtaining sealing of the encapsulation package of a component for detecting electromagnetic radiation as claimed in claim 9, characterised in that it also includes an additional stage that involves increasing the temperature of both parts in order to obtain reflow of the soldering alloy before both parts are brought into contact with each other.
